(19) United States
(12) Patent Application Publication
(10) Pub. No.: US 2025/0291225 A1
(43) Pub. Date: Sep. 18, 2025

(54) VARIABLE WAVELENGTH INTERFERENCE FILTER

(71) Applicant: SEIKO EPSON CORPORATION, Tokyo (JP)

(72) Inventor: Kei KUDO, Shiojiri-shi (JP)

(21) Appl. No.: 19/078,310

(22) Filed: Mar. 13, 2025

(30) Foreign Application Priority Data
Mar. 13, 2024 (JP) 2024-038754

(51) Int. Cl. G02F 1/21

(52) U.S. Cl. CPC G02F 1/21

(57) ABSTRACT

A variable wavelength interference filter includes a first substrate including a first reflection film; and a second substrate including a second reflection film facing the first reflection film. The second substrate includes a diaphragm including an annular groove surrounding a movable section at which the second reflection film is disposed, and an annular second electrode surrounding the second reflection film. The first substrate includes a first electrode facing the second electrode. A voltage is applied to a space between the first electrode and the second electrode to change a gap between the first reflection film and the second reflection film. A multilayer film that forms the second reflection film is formed so as to cover the diaphragm. The multilayer film has an electrically continuous structure that establishes electrical continuity between the multiple layers. The electrically continuous structure includes an electrically continuous portion having a symmetrical arrangement with respect to a center of the second reflection film.

The present application is based on, and claims priority from JP Application Serial Number 2024-038754, filed Mar. 13, 2024, the disclosure of which is hereby incorporated by reference herein in its entirety.

### BACKGROUND

### 1. Technical Field

The present disclosure relates to a variable wavelength interference filter.

### 2. Related Art

There has been a known variable wavelength interference filter that includes a pair of reflection mirrors facing each other and an electrostatic actuator, changes the distance between the pair of reflection mirrors to select light having a predetermined wavelength from light under measurement, and outputs the selected light. The reflection mirrors each include a multilayer film in which a low-refractive-index material and a high-refractive-index material are stacked on each other, and the fact that the high-refractive-index material is an electrically conductive material causes formation of a floating electrode in the multilayer film and accumulation of electric charges therein, which hinders the operation of the electrostatic actuator.

In view of the point described above, to prevent the electric charge accumulation, JP-A-2015-212752, for example, discloses that an electric wire is coupled to an end surface of the reflection mirror for electrical continuity to release the electric charges.

The distance between the pair of reflection mirrors is adjusted by the configuration in which the reflection mirror facing a movable substrate provided with a diaphragm moves forward and rearward relative to the reflection mirror facing a fixed substrate. The diaphragm, which is configured with a thin portion formed by an annular groove surrounding a movable portion at which the reflection mirror is disposed, is a structurally weak portion having a small thickness.

JP-A-2015-212752 is an example of the related art.

JP-A-2015-212752, however, has room for improvement.

In detail, JP-A-2015-212752 does not state or suggest improvement in strength of the diaphragm.

That is, a variable wavelength interference filter including a diaphragm having high impact resistance and excellent reliability has been demanded.

### SUMMARY

According to an aspect of the present disclosure, a variable wavelength interference filter including a first substrate including a first reflection film; and a second substrate including a second reflection film facing the first reflection film. The second substrate includes a diaphragm including an annular groove surrounding a movable section at which the second reflection film is disposed, and an annular second electrode surrounding the second reflection film. The first substrate includes a first electrode facing the second electrode. A voltage is applied to a space between the first electrode and the second electrode to change a gap between the first reflection film and the second reflection film. A multilayer film that forms the second reflection film is formed so as to cover the diaphragm. The multilayer film has an electrically continuous structure that establishes electrical continuity between the multiple layers. The electrically continuous structure includes an electrically continuous portion having a symmetrical arrangement with respect to a center of the second reflection film.

### BRIEF DESCRIPTION OF THE DRAWINGS

FIG. 1 is a plan view of an optical device according to a first embodiment.

FIG. 2 is a cross-sectional view of the optical device.

FIG. 3 is a plan view of a variable wavelength interference filter.

FIG. 4 is a cross-sectional view of the variable wavelength interference filter.

FIG. 5 is an enlarged view of a portion b in FIG. 4.

FIG. 6 is a plan view showing a planar aspect of a multilayer film.

FIG. 7 is a cross-sectional view taken along the line c-c in FIG. 6.

FIG. 8 shows graphs illustrating the amount of deformation of a diaphragm according to an aspect of the multilayer film arrangement.

FIG. 9 is a perspective view showing a result of a simulation of the multilayer film in the present embodiment.

FIG. 10 is a perspective view showing a result of a simulation of a multilayer film in Comparative Example.

FIG. 11 is a schematic configuration diagram of a spectral camera according to a second embodiment.

### DESCRIPTION OF EMBODIMENTS

### First Embodiment

### Configuration of Optical Device

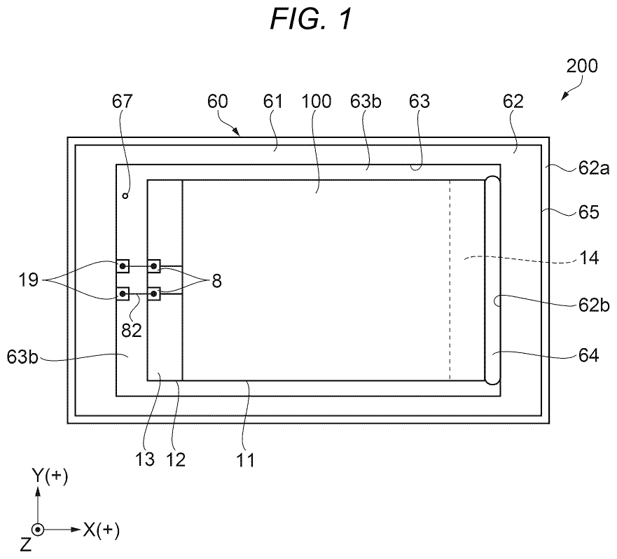

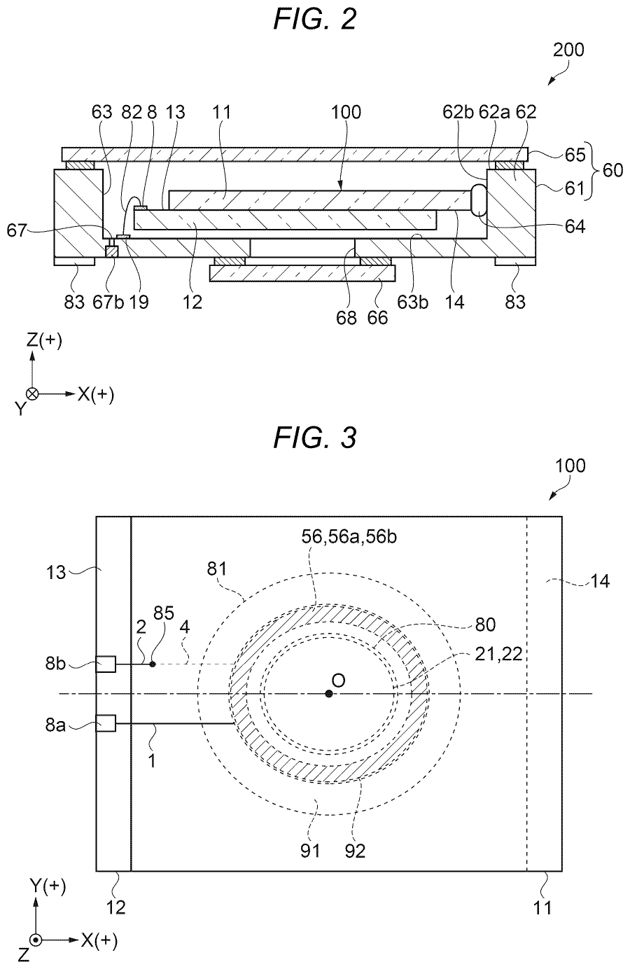

FIG. 1 is a plan view of an optical device. FIG. 2 is a cross-sectional view of the optical device.

The configurations of an optical device 200 and a variable wavelength interference filter 100 according to the present embodiment will be described with reference to FIGS. 1 and 2. The drawings each show an X-axis, a Y-axis, and a Z-axis that are three axes perpendicular to each other. It is assumed in the present embodiment that a +X direction is the direction in which the long sides of the optical device 200, which has a rectangular shape, extend. The direction along the −X axis is referred to as an “X direction”, the direction along the Y axis is referred to as a “Y direction”, and the direction along the Z axis is referred to as a “Z direction”. For example, the Y direction refers to both the direction toward the positive side in the Y direction, and the direction toward the negative side in the Y direction. The positive side in the Z direction is also referred to as an “upper side”, and the negative side in the Z direction is also referred to as a “lower side”. In the drawings below, dimensions and scales different from actual values are used in some cases for clarity of the description.

The optical device 200 is an apparatus that extracts light having a predetermined target wavelength from incident light under examination and outputs the extracted light, and is specifically an optical filter device including an enclosure 60 and the variable wavelength interference filter 100 housed in the enclosure 60. The optical device 200 may be preferably used, for example, in an optical module such as a colorimetric sensor or an electronic instrument such as a colorimeter and a gas analyzer.

The enclosure 60 includes a base 61 and a lid 65, and houses the variable wavelength interference filter 100 therein, as shown in FIG. 2.

The base 61 is a ceramic substrate formed by stacking ceramic thin layers on each other and baking the stack. A side wall section 62, which is a frame-shaped portion in a plan view of the filter, is provided at the surface of the base 61 that faces the lid 65, as shown in FIG. 1 and FIG. 2. The base 61 has a recess 63 formed so as to be surrounded by the side wall section 62. The lid 65 is bonded to a lid bonding surface 62a, which is a surface of the side wall section 62 that faces the lid 65. The variable wavelength interference filter 100 has a configuration in which a first substrate 11 and a second substrate 12 overlap with each other. The first substrate 11 is also referred to as a fixed substrate, and the second substrate 12 is also referred to as a movable substrate.

The variable wavelength interference filter 100 has a rectangular shape slightly smaller than the enclosure 60, and overhangs 13 and 14 are provided at the short sides of the variable wavelength interference filter 100 in a plan view. The overhang 13 is a protruding portion of the second substrate 12 that overhangs in the −X direction beyond one of the short sides of the first substrate 11, as shown in FIG. 2. The overhang 14 is a protruding portion of the first substrate 11 that overhangs in the +X direction beyond one of the short sides of the second substrate 12.

The variable wavelength interference filter 100 is fixed to a +X-side side wall 62b of the recess 63 of the base 61 via a fixing member 64. In detail, the end of the overhang 14 of the variable wavelength interference filter 100 is adhesively fixed to the side wall 62b of the recess 63 via the fixing member 64. In this configuration, the second substrate 12 is separate from a bottom 63b of the recess 63.

The bottom 63b of the recess 63 is provided with a light passage hole 68, through which light output from the variable wavelength interference filter 100 passes. The light passage hole 68 is covered by a light transmissive member 66, such as a glass plate, which serves as a lid and is bonded with an adhesive, such as low-melting-point glass.

The bottom 63b of the recess 63 is further provided with a seal hole 67, which passes through the enclosure 60 and communicates with the outer space. The seal hole 67 is a hole, for example, through which the gas in the enclosure 60 is suctioned or replaced with inert gas when the optical device 200 is manufactured, and can be sealed with a metal sealing member 67b (FIG. 2), such as Au, in a state in which the interior of the enclosure 60 is a vacuum or is depressurized.

The lid 65 has a rectangular external shape that is the same as that of the base 61 in the plan view, and is made of light transmissive glass. The lid 65 is bonded to the lid bonding surface 62a after the variable wavelength interference filter 100 is mounted on the base 61.

Note that FIG. 2 shows an example in which the variable wavelength interference filter 100 is fixed via the fixing member 64 to the +X-side side wall 62b of the recess 63 of the base 61, and the variable wavelength interference filter 100 may be fixed in another form. For example, in FIG. 2, the fixing member 64 adhesively fixes the end of the overhang 14 of the first substrate 11 to the side wall 62b of the recess 63. In another form, the fixing member 64 may adhesively fix the −Z-side surface of the second substrate 12 to a portion of the bottom 63b of the recess 63 that does not interfere with the light passage hole 68 in FIG. 2.

### Configuration of Variable Wavelength Interference Filter

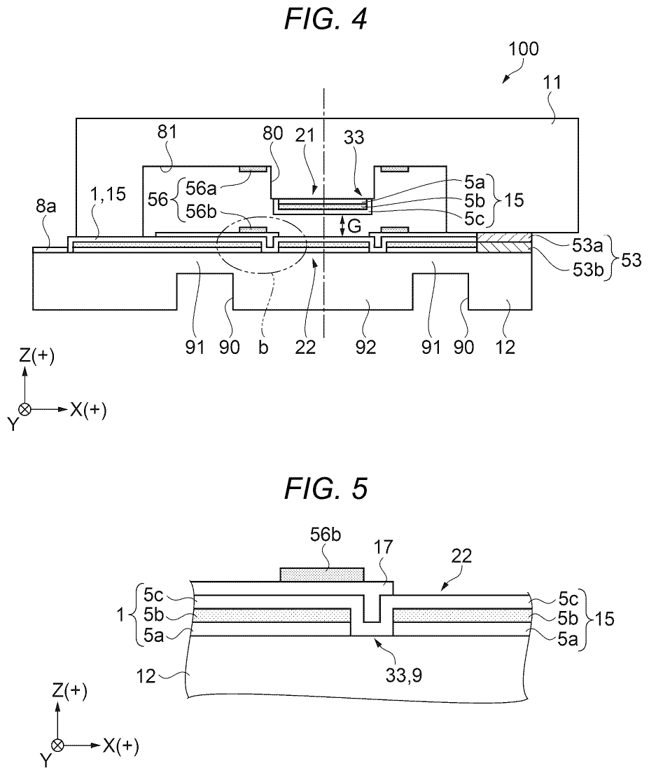

FIG. 3 is a plan view showing a schematic configuration of the variable wavelength interference filter. FIG. 4 is a cross-sectional view of key portions of the variable wavelength interference filter.

The variable wavelength interference filter 100 has the configuration in which the first substrate 11 and the second substrate 12 overlap with each other. The first substrate 11 and the second substrate 12 are each made, for example, of any of various types of glass or quartz crystal, and is assumed to be made of quartz glass in the present embodiment.

The first substrate 11 and the second substrate 12 are bonded to each other via a bonding film 53 into a unit, as shown in FIG. 4. In detail, a first bonding section 53a of the first substrate 11 and a second bonding section 53b of the second substrate 12 are each a plasma polymerized film primarily composed of polyorganosiloxane, and are bonded by siloxane bonding. The combination of the first bonding portion 53a of the first substrate 11 and the second bonding portion 53b of the second substrate 12 is referred to as the bonding film 53.

The +Z-side surface of the first substrate 11 is referred to as a front surface, and the surface opposite the front surface is referred to as an inner surface. The +Z-side surface of the second substrate 12 is referred to as an opposing surface, and the −Z-side surface of the second substrate 12 is referred to as a rear surface. The inner surface of the first substrate 11 and the opposing surface of the second substrate 12 face each other.

A first reflection film 21 is provided substantially at the center of the inner surface of the first substrate 11. A second reflection film 22 is provided at the opposing surface of the second substrate 12 at a position where the second reflection film 22 overlaps with the first reflection film 21. The first reflection film 21 and the second reflection film 22 are disposed so as to face each other with a gap G therebetween.

In other words, the first reflection film 21 and the second reflection film 22 are formed so as to face each other and create the gap G having a predetermined length.

An annular electrode placement groove 81 is provided in the first substrate 11 so as to surround a circular columnar installation mount 80, at which the first reflection film 21 is disposed. An annular first electrode 56a is provided in the electrode placement groove 81.

A second electrode 56b paired with the first electrode 56a is provided at the second substrate 12, and the first electrode 56a and the second electrode 56b form an electrostatic actuator 56. The electrostatic actuator 56 produces an electrostatic attraction according to a drive voltage applied to the space between the first electrode 56a and the second electrode 56b to adjust the gap G between the first reflection film 21 and the second reflection film 22. The first substrate 11 is formed to be thicker than the second substrate 12, and is therefore rigid enough not to bend even when the electrostatic attraction is produced by the electrostatic actuator 56.

An annular groove 90 is formed in the rear surface of the second substrate 12 so as to surround the second reflection film 22. An annular portion of the second substrate 12 that has a reduced thickness due to the groove 90 is referred to as a support 91. A portion of the second substrate 12 that is inside the support 91 and includes the second reflection film 22 is referred to as a movable section 92.

The support 91 is a deformable diaphragm having elasticity, and the movable section 92 can move forward and rearward relative to the first substrate 11 due to the electrostatic attraction produced by the electrostatic actuator 56. In the action described above, since the movable section 92 is thicker and therefore more rigid than the support 91, the movable section 92 does not change in shape even when the support 91 is pulled toward the first substrate 11 by the electrostatic attraction, so that the second reflection film 22 does not bend, and the first reflection film 21 and the second reflection film 22 can always be maintained parallel to each other.

In other words, the variable wavelength interference filter 100 includes the first substrate 11 including the first reflection film 21 and the second substrate 12 including the second reflection film 22 facing the first reflection film 21. The second substrate 12 includes the diaphragm having the annular groove 90 surrounding the movable section 92, at which the second reflection film 22 is disposed, and the annular second electrode 56b surrounding the second reflection film 22. The first substrate 11 includes the first electrode 56a facing the second electrode 56b. A voltage is applied to the space between the first electrode 56a and the second electrode 56b to change the gap G between the first reflection film 21 and the second reflection film 22.

The overhang 13 is provided with terminals 8a and 8b, as shown in FIG. 3.

The terminal 8a is a GND terminal and is coupled to a wire 1. The wire 1 is electrically coupled to the second electrode 56b and the second reflection film 22. In other words, the second reflection film 22 and the second electrode 56b at the second substrate 12 have the same potential.

A wire 2 is coupled to the terminal 8b. The wire 2 is electrically coupled to the first electrode 56a. In detail, the wire 2 extends from the second substrate 12, and is electrically continuous with a wire 4 via an electrically continuous bump 85, and the wire 4 extends to the first substrate 11, and is electrically coupled to the first electrode 56a.

Note that the overhang 13 is provided with, although not shown, a terminal or the like coupled to a wire used to detect the capacitance between the first reflection film 21 and the second reflection film 22.

Returning to FIG. 1, the description continues.

The bottom 63b of the recess 63 of the base 61 is provided with multiple base terminals 19 corresponding to the multiple terminals 8 of the overhang 13, as shown in FIG. 1. The terminals 8 and the corresponding base terminals 19 are electrically coupled to each other via bonding wires 82, as shown in FIG. 2. The base terminals 19 are electrically coupled to corresponding external terminals 83 formed at the outer side of the base 61 via wires that are not shown. The external terminals 83 also serve as mounted terminal of the optical device 200.

### Electrically Continuous Structure of Multilayer Film

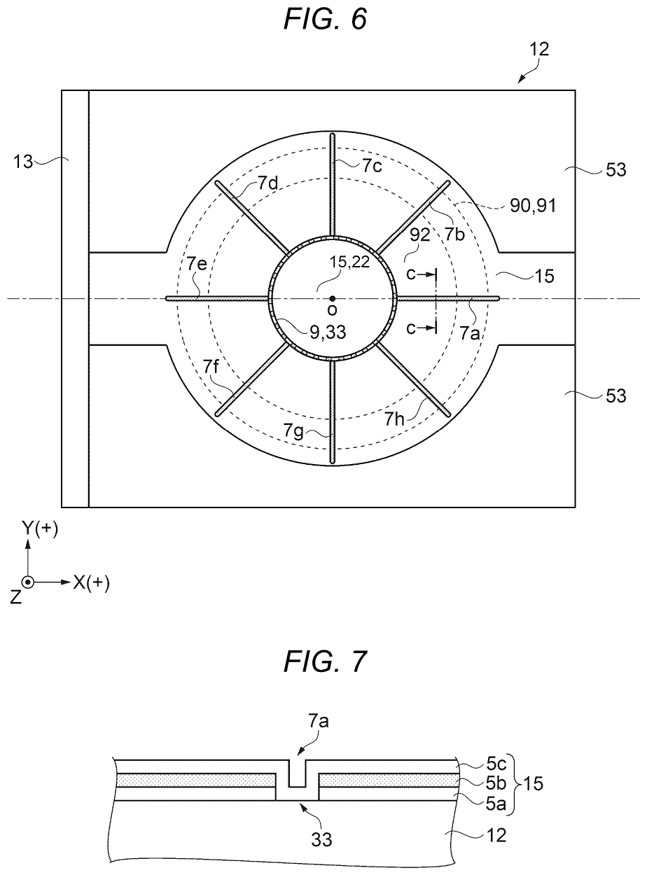

FIG. 5 is an enlarged view of a portion b in FIG. 4. FIG. 6 is a plan view showing a planar aspect of a multilayer film. FIG. 7 is a cross-sectional view taken along the line c-c in FIG. 6.

The second reflection film 22 is configured with a multilayer film 15, which is a stack of multiple high-refractive-index layers and low-refractive-index layers, as shown in FIG. 5. In detail, the multilayer film 15 has a three-layer structure in which a first layer 5a made of the high-refractive-index material, a second layer 5b made of the low-refractive-index material, and a third layer 5c made of the high-refractive-index are stacked on each other. In a preferable example, the first layer 5a and the third layer 5c are each made of Si as the high-refractive-index material. Si is also an electrically conductive material. The second layer 5b is made of SiO₂ as the low-refractive-index material.

Note that the multilayer film 15 does not necessarily have a three-layer structure, and may be any multilayer film in which multiple high-refractive-index layers and low-refractive-index layers are alternately stacked on each other.

The end surface of the multilayer film 15, which constitutes the second reflection film 22, is covered with the uppermost third layer 5c, so that the electrical continuity between the three layers is established. In detail, the end surfaces of the first layer 5a and the second layer 5b are covered with the third layer 5c, so that the electrical continuity between the three layers is established. The electrically continuous structure is called an electrically continuous structure 33. In other words, the multilayer film 15 includes the electrically continuous structure 33, which establishes electrical continuity between the multiple layers. The electrically conductive material forms one of the optical films that constitute the multilayer film 15. The end surface of the multilayer film 15 is covered with the third layer 5c made of the electrically conductive material for electrical continuity. Note that the electrical continuity is not necessarily established by the configuration in which the end surface is covered with the third layer 5c, and may be established by any single electrically conductive layer.

Further, the −X side of the electrically continuous structure 33 is provided with the wire 1, which is the multilayer film 15, and a light transmissive, electrically conductive layer 17 is formed over the wire 1. The light transmissive, electrically conductive layer 17 is an ITO layer, and the second electrode 56b is formed on the light transmissive, electrically conductive layer 17. The wire 1 and the second electrode 56b are thus electrically coupled to each other.

The multilayer film 15 in the present embodiment is formed over a wide region also around the second reflection film 22, as shown in FIG. 6. In detail, the multilayer film 15 has a concentric circular shape larger than the second reflection film 22, and is slightly larger than the diaphragm including the annular groove 90 surrounding the movable section 92. In other words, the multilayer film 15, which forms the second reflection film 22, is formed so as to cover the diaphragm. The multilayer film 15 has the same GND potential as the second reflection film 22. The bonding film 53 is provided outside the multilayer film 15.

The second reflection film 22 is a portion of the multilayer film 15 that is separated by the annular electrically continuous structure 33, and the resultant annular pattern is called an annular pattern 9. The annular pattern 9 is an electrically continuous portion, which can prevent electric charges from accumulating in the multilayer film in the second reflection film 22.

Multiple linear wiring patterns 7a to 7h extend radially from the annular pattern 9. The wiring patterns 7a to 7h are part of the electrically continuous portion.

The wiring pattern 7a extends from a center o of the second reflection film 22 in the +X direction, which corresponds to an angle of 0°, to a portion beyond the groove 90. The wiring pattern 7b extends from the center o in the direction corresponding to an angle of 45° to a portion beyond the groove 90.

The wiring pattern 7c extends from the center o in the +Y direction, which corresponds to an angle of 90°, to a portion beyond the groove 90. The wiring pattern 7d extends from the center o in the direction corresponding to an angle 135° to a portion beyond the groove 90.

The wiring pattern 7e extends from the center o in the −X direction, which corresponds to an angle of 180°, to a portion beyond the groove 90. The wiring pattern 7f extends from the center o in the direction corresponding to an angle of 225° to a portion beyond the groove 90.

The wiring pattern 7g extends from the center o in the −Y direction, which corresponds to an angle of 270°, to a portion beyond the groove 90. The wiring pattern 7h extends from the center o in the direction corresponding to an angle of 315° to a portion beyond the groove 90.

That is, the wiring patterns 7a to 7d and the wiring patterns 7e to 7h are point-symmetrical with respect to the center o of the second reflection film 22. In other words, the electrically continuous structure 33 includes the wiring patterns 7a to 7d and the wiring patterns 7e to 7h, which are disposed symmetrically with respect to the center o of the second reflection film 22 and serve as the electrically continuous portion. The electrically continuous portion includes the wiring patterns 7a to 7h radially extending from the movable section 92 to the diaphragm. The electrically continuous portion further includes the annular pattern 9, which has an annular shape surrounding the second reflection film 22, and the radial wiring patterns 7a to 7h are extracted from the annular pattern 9. Note that the number of wiring patterns is not limited to eight and may be any value greater than one.

The cross section of the wiring pattern 7a has the electrically continuous structure 33, as shown in FIG. 7. In detail, the end surfaces of the first layer 5a and the second layer 5b are covered with the third layer 5c, so that the electrical continuity between the three layers is established. Note that FIG. 7 does not show the light transmissive, electrically conductive layer 17 (FIG. 5).

The area of the multilayer film 15 outside the annular pattern 9 is considerably greater than the area of the second reflection film 22, as shown in FIG. 6. Since the multilayer film 15 has high resistivity, there is a concern that the electric charges cannot be entirely released in case where locations are separated by too large a distance from the electrically continuous structure 33.

In contrast, the present embodiment, in which the wiring patterns 7a to 7h electrically segment the multilayer film 15 into eight trapezoidal regions, can prevent electric charges from accumulating in the multilayer film 15 in each of the trapezoidal regions.

Furthermore, the multilayer film 15 having a three-layer structure covers the diaphragm including the annular groove 90, so that the thin support 91 backed with the multilayer film 15 is reinforced. The strength of the diaphragm, which is thin and structurally weak, can thus be increased.

Returning to FIG. 4, the description continues.

The first reflection film 21 at the first substrate 11 is also configured with another multilayer film 15 having a three-layer structure, as shown in FIG. 4. The end surface of the multilayer film 15 that constitutes the first reflection film 21 is covered with the uppermost third layer 5c, so that electrical continuity between the three layers is established. In detail, the electrically continuous structure 33, in which the end surfaces of the first layer 5a and the second layer 5b are covered with the third layer 5c, establishes the electrical continuity between the three layers. The configuration described above prevents electric charges from accumulating in the multilayer film 15.

Note that the functional film including the multilayer film 15, the light transmissive, electrically conductive layer 17, and the second electrode 56b described above can be formed, for example, by forming the film by using a known film formation method such as sputtering, vapor deposition, and CVD, and then patterning the film by using photolithography.

### Results of Simulation of Strength of Diaphragm

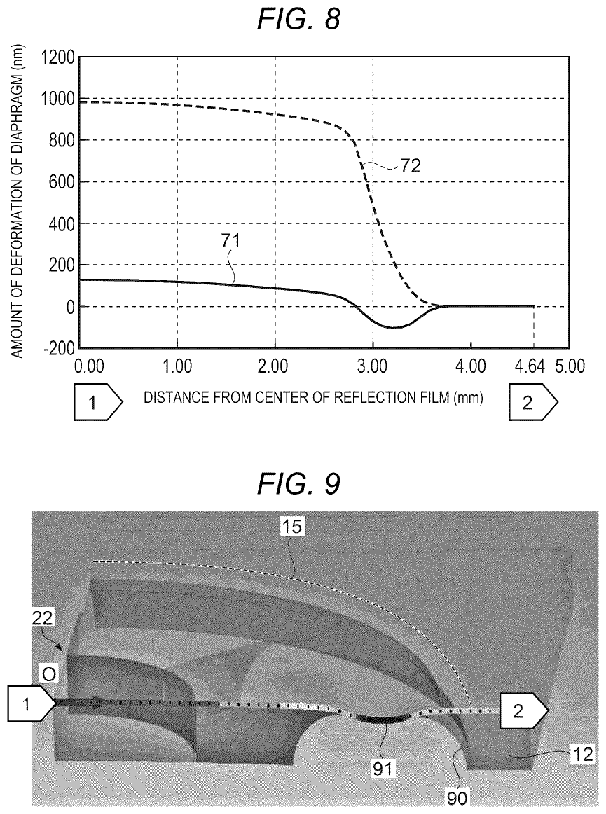

FIG. 8 shows graphs illustrating the amount of deformation of the diaphragm according to the aspect of the multilayer film arrangement, with the horizontal axis representing the distance (mm) from the center o of the second reflection film 22, the vertical axis representing the amount of deformation (nm) of the diaphragm. FIG. 9 is a perspective view showing a result of a simulation of the multilayer film in the present embodiment. FIG. 10 is a perspective view showing a result of a simulation of a multilayer film in Comparative Example, and corresponds to FIG. 9.

The multilayer film 15 in the present embodiment is provided so as to completely cover the diaphragm as described above, so that the outer circumferential edge of the multilayer film 15 is located outside the annular groove 90, as shown in FIG. 9.

In contrast, the outer circumferential edge of a multilayer film 25 in the variation is located in the middle of the annular groove 90, as shown in FIG. 10. In other words, the outer circumferential edge of the multilayer film 25 is located in the middle of the support 91.

A graph 71 in FIG. 8 is a result of the simulation in a state in which the diaphragm is stationary, and is a result of calculation of a state in which only stress induced in the multilayer film 15 including the second reflection film 22 and in a film including the second electrode 56b acts on the stationary planar second substrate 12.

The graph 71 is substantially flat, which indicates that no stress concentration is observed in the multilayer film 15 in the present embodiment, and that the deformation of the diaphragm falls within a range of about 230 nm, which is a very small value.

In contrast, a graph 72, which is a result of the simulation of the multilayer film 25 in the variation, shows that stress concentration occurs at the middle of the support 91, where the outer circumferential edge of the multilayer film 25 is located, and that the amount of deformation reaches about 1000 nm. In the variable wavelength interference filter 100, since the gap G between the first reflection film 21 and the second reflection film 22 needs to be controlled to fall within a range of the order of several nm, the amount of deformation described above is too large. As described above, the multilayer film 15 in the present embodiment can reinforce the diaphragm with no occurrence of stress concentration to enhance the impact resistance, and the electrically continuous structure 33 including the wiring patterns 7a to 7h can prevent electric charges from accumulating in the multilayer film 15.

As described above, the variable wavelength interference filter 100 according to the present embodiment can provide the advantages below.

The variable wavelength interference filter 100 includes: the first substrate 11 including the first reflection film 21, and the second substrate 12 including the second reflection film 22 facing the first reflection film 21. The second substrate 12 includes the diaphragm including the annular groove 90 surrounding the movable section 92, at which the second reflection film 22 is disposed, and the annular second electrode 56b surrounding the second reflection film 22. The first substrate 11 includes the first electrode 56a facing the second electrode 56b. A voltage is applied to the space between the first electrode 56a and the second electrode 56b to change the gap G between the first reflection film 21 and the second reflection film 22. The multilayer film 15, which forms the second reflection film 22, is formed so as to cover the diaphragm. The multilayer film 15 includes the electrically continuous structure 33, which establishes electrical continuity between the multiple layers. The electrically continuous structure 33 has the wiring patterns 7a to 7d and the wiring patterns 7e to 7h serving as the electrically continuous portion and disposed symmetrically with respect to the center o of the second reflection film 22.

The multilayer film 15, which backs the thin support 91, can therefore increase the strength of the diaphragm, which is thin and structurally weak. Furthermore, the electrically continuous portion including the wiring patterns 7a to 7h, which have a symmetrical arrangement with respect to the center o of the second reflection film 22, can prevent electric charges from accumulating in the multilayer film 15. The electrostatic actuator 56 is therefore driven with enhanced reliability.

The thus provided variable wavelength interference filter 100 therefore includes a diaphragm having high impact resistance and excellent reliability.

The electrically continuous portion includes the wiring patterns 7a to 7h radially extending from the movable section 92 to the diaphragm. The configuration described above, in which the wiring patterns 7a to 7h electrically segment the multilayer film 15, which has a wide area and high resistivity, into eight trapezoidal regions, can efficiently release the electric charges in the multilayer film 15 in each of the trapezoidal regions.

The second reflection film 22 and the second electrode 56b at the second substrate 12 have the same potential.

The second substrate 12 is therefore electrically stabilized.

The end surface of the multilayer film 15 is covered with the third layer 5c made of an electrically conductive material for electrical continuity. The configuration described above prevents electric charges from accumulating in the multilayer film 15.

The electrically conductive material forms one of the optical films that constitute the multilayer film 15.

The electrically conductive optical film that constitutes the multilayer film 15 can therefore be used as the electrically conductive material.

The electrically continuous portion includes the annular pattern 9, which has an annular shape and surrounds the second reflection film 22, and the radial wiring patterns 7a to 7h are extracted from the annular pattern 9.

The configuration described above prevents electric charges from accumulating in the multilayer film 15.

### Second Embodiment

### Spectral Camera

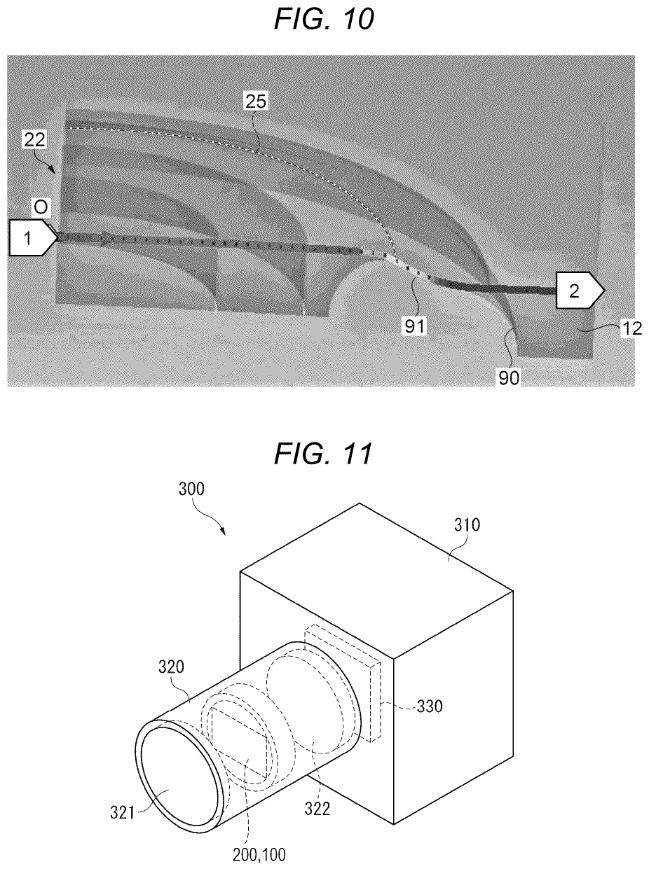

FIG. 11 is a schematic configuration diagram of a spectral camera according to a second embodiment.

A spectral camera 300 according to the present embodiment shown in FIG. 11 includes the optical device 200 equipped with the variable wavelength interference filter 100 according to the embodiment described above. In the following description, the same portions as those in the embodiment described above have the same reference characters, and redundant descriptions thereof will be omitted.

The spectral camera 300 is an infrared camera including the optical device 200 equipped with the variable wavelength interference filter 100, and includes a camera body 310, an imaging lens unit 320, and an imager 330.

The camera body 310 is a portion gripped and operated by a user.

The imaging lens unit 320 is attached to the camera body 310, and guides incident image light to the imager 330. The imaging lens unit 320 includes an objective lens 321, an image forming lens 322, and the optical device 200 provided between the lenses, as shown in FIG. 11.

The imager 330 is configured with a light receiving element, and captures the image light guided by the imaging lens unit 320.

The thus configured spectral camera 300, which transmits light having a wavelength to be captured by the optical device 200 having excellent reliability, can capture a spectral image formed by light having a desired wavelength.

What is claimed is:

1. A variable wavelength interference filter comprising:
a first substrate including a first reflection film; and
a second substrate including a second reflection film facing the first reflection film,
wherein the second substrate includes a diaphragm including an annular groove surrounding a movable section at which the second reflection film is disposed, and an annular second electrode surrounding the second reflection film,
the first substrate includes a first electrode facing the second electrode,
a voltage is applied to a space between the first electrode and the second electrode to change a gap between the first reflection film and the second reflection film,
a multilayer film that forms the second reflection film is formed so as to cover the diaphragm,
the multilayer film has an electrically continuous structure that establishes electrical continuity between the multiple layers, and
the electrically continuous structure includes an electrically continuous portion having a symmetrical arrangement with respect to a center of the second reflection film.

2. The variable wavelength interference filter according to claim 1, wherein
the electrically continuous portion has wiring patterns radially extending from the movable section to the diaphragm.

3. The variable wavelength interference filter according to claim 1, wherein
the second reflection film and the second electrode at the second substrate have the same potential.

4. The variable wavelength interference filter according to claim 1, wherein
an end surface of the multilayer film is covered with an electrically conductive material for electrical continuity.

5. The variable wavelength interference filter according to claim 4, wherein
the electrically conductive material is one of optical films that constitute the multilayer film.

6. The variable wavelength interference filter according to claim 2, wherein
the electrically continuous portion has an annular pattern having an annular shape and surrounding the second reflection film, and
the radial annular patterns are extracted from the annular pattern.
